(19) United States
(12) Patent Application Publication
(10) Pub. No.: US 2004/0045132 A1
(43) Pub. Date: Mar. 11, 2004

(54) Ergonomic handle for bicycle

(76) Inventor: Kenny Chen, Chang Hua Hsien (TW)

Correspondence Address: CHARLES E. BAXLEY, ESQUIRE, Hart, Baxley, Daniel & Holton, 59 John St, 5 Fl, New York, NY, 10038, US

(21) Appl. No.: 10/294,349

(22) Filed: Nov. 14, 2002

(30) Foreign Application Priority Data
Sep. 9, 2002 (TW) 91214079

(51) Int. Cl. B62B 1/00

(52) U.S. Cl. 16/430

(57) ABSTRACT

An ergonomic handle is provided for a bicycle. The ergonomic handle includes a cross member to be mounted on the front fork of the bicycle, two bent members each extending from one of two opposite ends of the cross member and two curved members each extending from one of the bent members and including a grip portion near its free end. The grip portion of each of the curved members includes a convex upper side. The ergonomic handle is made of a compound material. The grip portion of each of the curved members includes a convex upper side for intimate contact with the palm of the rider's hand. The grip portion of each of the curved members includes a planar face formed on the lower side for increasing an area for contact with the fingers of the rider's hand. The planar face extends in a longitudinal direction of the grip portion.

### BACKGROUND OF INVENTION

1. Field of Invention

The present invention relates to an ergonomic handle for a bicycle.

2. Related Prior Art

Various handles have been used for various bicycles. A typical handle for a so-called racing bicycle includes a cross member connected with the front fork of the bicycle, two bent members each extending from one of two opposite ends of the cross member and two curved members each extending from one of the bent members. While riding the bicycle slowly, a rider usually feels comfortable keeping his or her back straight. Accordingly, the rider holds the cross member of the handle. While riding the bicycle at a medium speed, the rider lowers his or her body a little bit for reducing damping by air. Accordingly, the rider holds the bent members of the handle. While rushing with the bicycle, the rider lowers his or her body even further for minimizing damping by air. Accordingly, the rider holds the curved members of the handle. However, this typical handle fails to provide a comfortable feel. Moreover, this typical handle becomes slippery and therefore difficult to grasp when it rains or the rider sweats.

The present invention is therefore intended to obviate or at least alleviate the problems encountered in prior art.

### SUMMARY OF INVENTION

It is an objective of the present invention to provide an ergonomic handle.

It is another objective of the present invention to provide a non-slippery handle.

According to the present invention, an ergonomic handle is provided for a bicycle. The ergonomic handle includes a cross member to be mounted on the front fork of the bicycle, two bent members each extending from one of two opposite ends of the cross member and two curved members each extending from one of the bent members and including a grip portion near its free end. The grip portion of each of the curved members includes a convex upper side. The ergonomic handle is made of a compound material. The grip portion of each of the curved members includes a convex upper side for intimate contact with the palm of the rider's hand. The grip portion of each of the curved members includes a planar face formed on the lower side for increasing an area for contact with the fingers of the rider's hand. The planar face extends in a longitudinal direction of the grip portion.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings.

FIG. 1 is a perspective view of an ergonomic handle for a bicycle according to the present invention.

FIG. 2 is another perspective view of the ergonomic handle of FIG. 1.

FIG. 3 is a top view of the ergonomic handle of FIG. 1.

FIG. 4 is similar to FIG. 3, but showing it held by hands.

FIG. 5 is similar to FIG. 4, but showing it held by hands in another manner.

FIG. 6 is similar to FIG. 5, but showing it held by hands in another manner.

### DETAILED DESCRIPTION OF PREFERRED EMBODIMENT

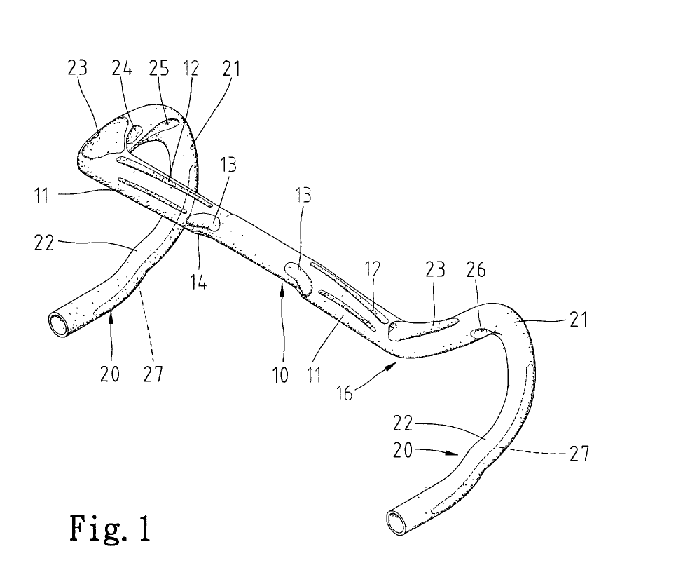

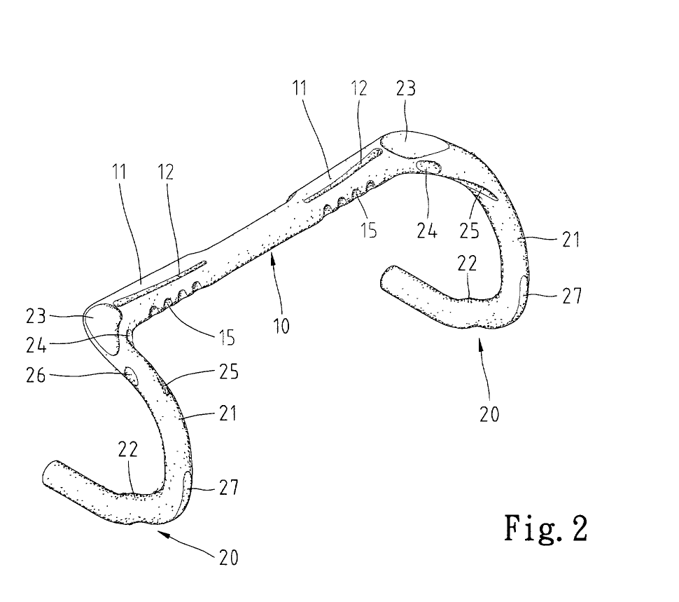

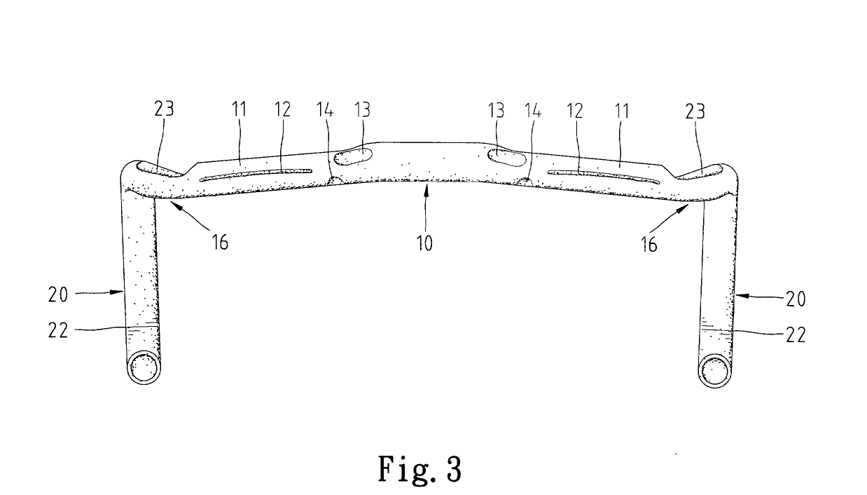

FIGS. 1-3 show a handle according to the preferred embodiment of the present invention for installment on a bicycle. The handle includes a cross member 10 to be mounted on the front fork of the bicycle, two bent members 16 each extending from one of two opposite ends of the cross member 10 and two curved members 20 each extending from one of the bent members 16. The cross member 10 and the bent members 16 substantially extend in a same plane, while the curved members 20 extend in two other planes, respectively. In the preferred embodiment, the cross member 10, the bent members 16 and the curved member

The cross member 10 includes two grip portions 11 each positioned near to one of the opposite ends of the cross member 10. Each of the grip portions 11 is like an oval instead of a circle in a cross-sectional view taken in a plane perpendicular to a length thereof. In other words, the grip portions 11 are flat. In the preferred embodiment, the handle is made from a compound material such as carbon fiber so that the grip portions 11 can be made flat easily. Each of the grip portions 11 includes a plurality of palm recesses 12, an upper thumb recess 13, a lower thumb recess 14 and four finger recesses 15. The palm recesses 12 assume an elongated form extending in a substantially longitudinal direction of the cross member 10 for contact with the palm of a rider's hand. The thumb recesses 13 and 14 assume an oblong form for receiving the thumb of the rider's hand. The finger recesses 15 assume a substantially circular form for receiving the fingers of the rider's hand.

Each of the bent members 16 includes a palm recess 23 defined in the upper side and a thumb recess 26 defined in an internal side. The palm recess 23 assumes a substantially triangular form for receiving a portion of the palm near the thumb. The thumb recess 26 assumes an oblong form for receiving the thumb.

Each of the curved members 20 includes a recess 25 through which extends a sheath (not shown) for a wire leading to a brake. Each of the curved members 20 is formed with a grip portion 22 near its free end. The grip portion 22 includes a convex upper side for intimate contact with the palm of the rider's hand. The grip portion 22 includes a planar face 27 formed on the lower side for increasing an area for contact with the fingers of the rider's hand. The planar face 27 assumes an elongated form extending in a longitudinal direction of the grip portion 22.

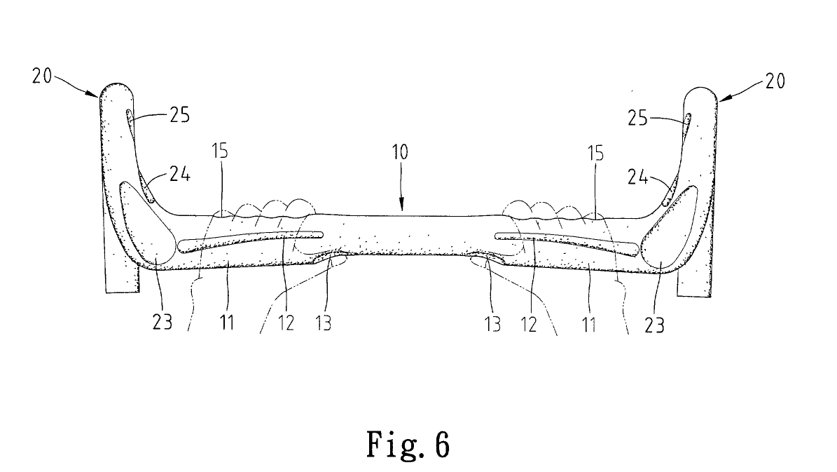

While riding the bicycle slowly, the rider usually feels comfortable keeping his or her back straight. Accordingly, the rider holds the cross member 10 with his or her hands as shown in FIG. 6. The rider grips each of the grip portions 11 with one of the hands, having the palms in contact with the palm recesses 12, the thumb in the upper thumb recess 13 or the lower thumb recess 14 and the tips of the fingers in the finger recesses 15.

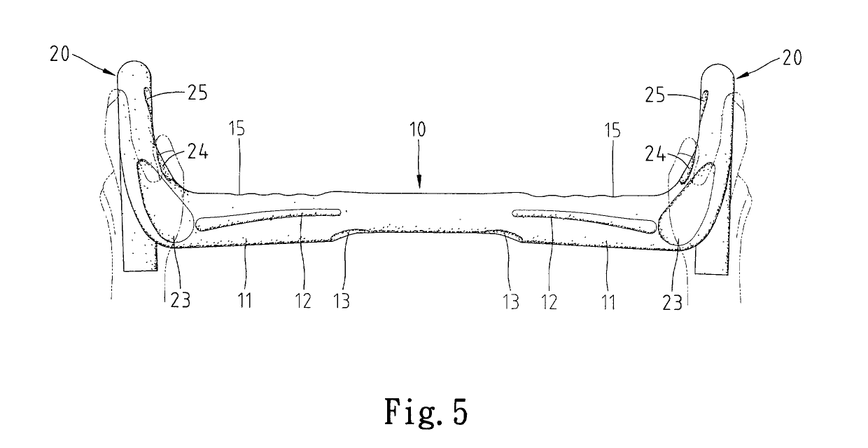

While riding the bicycle at a medium speed, the rider lowers his or her body for reducing damping by air. Accordingly, the rider grips each of the bent members 16 as shown in FIG. 5, having the portion of the palm near the thumb in the palm recess 23 and the thumb in the thumb recess 26.

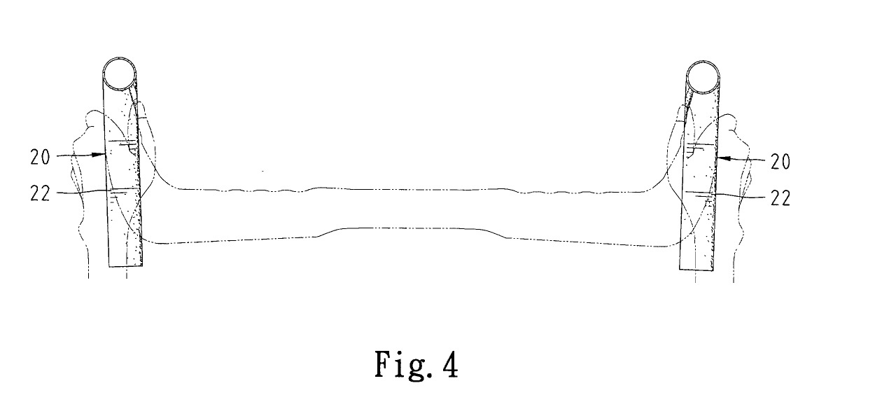

While rushing with the bicycle, the rider lowers his or her body even further for minimizing damping by air. Accordingly, the rider grips each of the grip portions 22 with one of the hands as shown in FIG. 4, having the palm in contact with the upper side thereof and the fingers in contact with the planar face 27.

The handle according to the preferred embodiment of the present invention provides a comfortable feel. Moreover, this typical handle becomes slippery and therefore difficult to grasp when it rains or the rider sweats.

The present invention has been described via illustration of the preferred embodiment. After a study of this specification, those skilled in the art can derive variations from the preferred embodiment. Therefore, the preferred embodiment is only taken as an example, and shall not limit the scope of the present invention defined in the claims.

What is claimed is:

1. An ergonomic handle including:
a cross member to be mounted on the front fork of a bicycle;
two bent members each extending from one of two opposite ends of the cross member; and
two curved members each extending from one of the bent members and including, near its free end, a grip portion with a convex upper side for intimate contact with the palm.

2. The ergonomic handle according to claim 1 wherein the ergonomic handle is made of a compound material.

3. The ergonomic handle according to claim 1 wherein the grip portion of each of the curved members includes a planar face formed on the lower side for increasing an area for contact with the fingers.

4. The ergonomic handle according to claim 4 wherein the planar face extends in a longitudinal direction of the grip portion.

5. The ergonomic handle according to claim 1 wherein each of the curved members includes a recess through which extends a sheath for a wire leading to a brake.

6. The ergonomic handle according to claim 1 wherein each of the bent members includes a palm recess in the upper side for receiving a portion of the palm near the thumb.

7. The ergonomic handle according to claim 6 wherein the palm recess of each of the bent members assumes a substantially triangular form.

8. The ergonomic handle according to claim 1 wherein each of the bent members includes a thumb recess defined in an external side.

9. The ergonomic handle according to claim 8 wherein the thumb recess of each of the bent members assumes a substantially oblong form for receiving the thumb.

10. The ergonomic handle according to claim 1 wherein the cross member includes two grip portions formed thereon.

11. The ergonomic handle according to claim 10 wherein the grip portions of the cross member are flat.

12. The ergonomic handle according to claim 10 wherein each of the grip portions includes at least one palm recess defined in the upper side for contact with the palm.

13. The ergonomic handle according to claim 12 wherein the at least one palm recess defined in each of the grip portions of the cross member extends in a substantially longitudinal direction.

14. The ergonomic handle according to claim 10 wherein each of the grip portions includes a thumb recess defined in the upper side for receiving the thumb.

15. The ergonomic handle according to claim 10 wherein each of the grip portions includes a thumb recess defined in the lower side for receiving the thumb.

16. The ergonomic handle according to claim 10 wherein each of the grip portions includes four finger recesses for receiving the fingers.

17. The ergonomic handle according to claim 16 wherein the finger recesses are substantially circular.

18. An ergonomic handle including:
a cross member to be mounted on the front fork of a bicycle;
two bent members each extending from one of two opposite ends of the cross member and including a palm recess defined therein; and
two curved members each extending from one of the bent members.

19. The ergonomic handle according to claim 18 wherein each of the curved members includes, near its free end, a grip portion with a convex upper side for intimate contact with the palm.

20. The ergonomic handle according to claim 18 wherein the ergonomic handle is made of a compound material.
